(19) United States
(12) Patent Application Publication
(10) Pub. No.: US 2012/0233262 A1
(43) Pub. Date: Sep. 13, 2012

(54) MESSAGE SIGNATURE METHOD AND DEVICE

(76) Inventor: Weiguo TAN, Shenzhen (CN)

(21) Appl. No.: 13/479,827

(22) Filed: May 24, 2012

Related U.S. Application Data
(63) Continuation of application No. PCT/CN2010/078550, filed on Nov. 9, 2010.

(30) Foreign Application Priority Data
Nov. 25, 2009 (CN) 200910226252.5

(51) Int. Cl. G06F 15/16

(52) U.S. Cl. 709/204

(57) ABSTRACT

The present invention discloses a message signature method, which includes: selecting a signature template that includes a signature variable for a message to be sent; parsing the signature variable in the signature template to obtain a current value of the signature variable, and filling the current value of the signature variable in the signature template to obtain a signed message; and sending the signed message. Meanwhile, the present invention further discloses a message signature device. With the present invention, signature content that changes dynamically can be obtained, which makes the message signature more interesting and personalized, easy to be implemented, and highly practicable.

### CROSS-REFERENCE TO RELATED APPLICATIONS

This application is a continuation of International Application No. PCT/CN2010/078550, filed on Nov. 9, 2010, which claims priority to Chinese Patent Application No. 200910226252.5, filed on Nov. 25, 2009, both of which are hereby incorporated by reference in their entireties.

### FIELD OF THE INVENTION

The present invention relates to the field of communications technologies, and in particular, to a message signature method and device.

### BACKGROUND OF THE INVENTION

A short message signature service is a short message value-added service, which provides a quick, convenient, and personalized signature manner for mobile phone users. The service is particularly suitable for young, fashionable, and lively users in pursuit of personalization and interest, and is also of value for customer care. Short message signature means: in the process that a calling user sends a short message, the system automatically attaches a personalized signature to the end of the short message content sent by the calling user, and then sends the short message to a called mobile phone user. If the total length of the short message content sent by the user and the signature content is greater than a maximum length of a short message, the system directly sends the short message content to the receiving party without adding the content of the short message signature.

A method for implementing short message signature in the prior art is as follows:

After receiving a short message, an SMSC (Short Message Service Center, short message center) notifies a DCS (Data Center for Short Message Service, data center for short message service), the DCS judges whether the signature service exists, and if yes, the SMSC adds signature content to the short message content and then forwards the short message to a called terminal; otherwise, the SMSC directly forwards the short message to the called terminal.

During the implementation of the present invention, the inventor finds that the prior art has the following deficiencies.

The signature content cannot be dynamically changed, and the signature must be set by a user first and saved on a server, so that the user has to set the signature again and save it on the server if the user intends to change the signature content, which causes trouble in operation.

Another method for short message signature of a communication terminal in the prior art enables addition of different signatures to a short message according to different target objects that receive the short message. The method includes the following steps. A user creates multiple signature templates and marks them respectively. Meanwhile, the user has to set a signature rule including manual signature and automatic signature, and set multiple matching options for the automatic signature rule. When a short message is edited, the user may select a signature template or the system automatically adds a signature template according to the signature rule set by the user.

During the implementation of the present invention, the inventor finds that the prior art has the following deficiencies.

The signature content is based on the set template and cannot be dynamically changed, and in order to realize new signature content, a client needs to be upgraded and a user creates a new signature template; in addition, the signature can only be parsed by the client, which has weak function.

### SUMMARY OF THE INVENTION

An embodiment of the present invention provides a message signature method, for implementing dynamic change of signature content simply and easily. The method includes:

selecting a signature template that includes a signature variable for a message to be sent;

parsing the signature variable in the signature template to obtain a current value of the signature variable, and filling the current value of the signature variable in the signature template to obtain a signed message; and

sending the signed message.

An embodiment of the present invention further provides a message signature device, for implementing dynamic change of signature content simply and easily. The device includes:

a selection module, configured to select a signature template that includes a signature variable for a message to be sent;

a parsing module, configured to parse the signature variable in the signature template to obtain a current value of the signature variable, and fill the current value of the signature variable in the signature template to obtain a signed message; and

a sending module, configured to send the signed message.

In the embodiments of the present invention, a signature template that includes a signature variable is selected for a message to be sent; and the signature variable in the signature template is parsed to obtain a current value of the signature variable, and the current value of the signature variable is filled in the signature template to obtain a signed message. During the implementation of signature, signature content that changes dynamically can be obtained by parsing the signature variable in the signature template without user operation or client upgrade, which makes the message signature more interesting and personalized, easy to be implemented, and highly practicable.

### BRIEF DESCRIPTION OF THE DRAWINGS

To illustrate the technical solutions in the embodiments of the present invention or in the prior art more clearly, the accompanying drawings for describing the embodiments or the prior art are provided briefly below. Apparently, the accompanying drawings in the following description are only some embodiments of the present invention, and persons skilled in the art can derive other drawings from the accompanying drawings without creative efforts. In the drawings:

FIG. 1 is a flow chart of a message signature method in an embodiment of the present invention;

FIG. 2 is a schematic diagram illustrating a process of requesting a user location from an LBS in an embodiment of the present invention;

FIG. 3 is a schematic diagram illustrating a process of requesting weather from a weather server in an embodiment of the present invention;

FIG. 4 is a schematic structural diagram of a message signature device in an embodiment of the present invention;

FIG. 5 is a schematic structural diagram of a selection module in an embodiment of the present invention;

FIG. 6 is a schematic structural diagram of a client for short message signature in an embodiment of the present invention;

FIG. 7 is a schematic structural diagram of a server end for short message signature in an embodiment of the present invention;

FIG. 8 is a processing flow chart of a specific example of short message signature in an embodiment of the present invention;

FIG. 9 is schematic structural diagram of a client for multimedia message signature in an embodiment of the present invention;

FIG. 10 is a schematic structural diagram of a server end for multimedia message signature in an embodiment of the present invention; and

FIG. 11 is a processing flow chart of a specific example of multimedia message signature in an embodiment of the present invention.

### DETAILED DESCRIPTION OF THE EMBODIMENTS

In order to make the objectives, technical solutions, and advantages of the embodiments of the present invention more comprehensible, the embodiments of the present invention are illustrated in further detail below with reference to the accompanying drawings. Herein, the exemplary embodiments of the present invention and description thereof are for explaining the present invention instead of limiting the present invention.

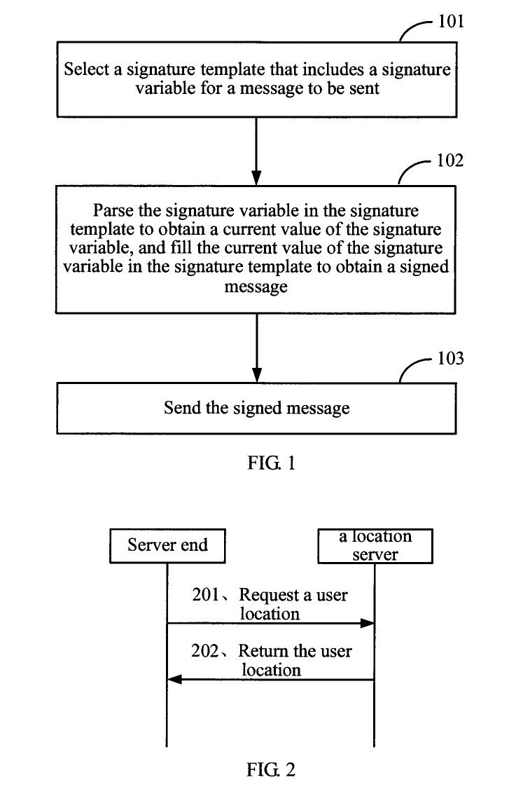

As shown in FIG. 1, the flow of a message signature method in an embodiment of the present invention may include the following steps:

Step 101: Select a signature template that includes a signature variable for a message to be sent.

Step 102: Parse the signature variable in the signature template to obtain a current value of the signature variable, and fill the current value of the signature variable in the signature template to obtain a signed message.

Step 103: Send the signed message.

As can be known from the flow shown in FIG. 1, a signature template that includes a signature variable is selected for a message to be sent; and the signature variable in the signature template is parsed to obtain a current value of the signature variable, and the current value of the signature variable is filled in the signature template to obtain a signed message. During the implementation of signature, signature content that changes dynamically can be obtained by parsing the signature variable in the signature template without user operation or client upgrade, which makes the message signature more interesting and personalized, easy to be implemented, and highly practicable.

In specific implementation, in step 101, a signature template may be selected for a message to be sent in many ways, for example, a user may manually select a signature template, and a signature template may also be selected according to a preset signature rule.

A signature rule is a rule that is preset and related to a signature, for example, different signature templates are set for different contacts, groups, numbers, or number segments; or, no signature template is used for some contacts, groups, numbers, or number segments; a signature is used only on some specific dates, for example, holidays and anniversaries; a signature is used only in some specific time periods; a signature is used only once per day for the same contact.

According to the specific side that sets and parses a signature rule, a signature rule may be classified into a client signature rule and a server end signature rule. A client signature rule is set and parsed by a client, and a server end signature rule is set and parsed by a server end. Generally, one of them is selected for rule matching, and a corresponding signature template is selected according to a matching result. That is, in specific implementation, the step of selecting the signature template for the message to be sent in step 101 may include: selecting the signature template according to a preset client signature rule or a server end signature rule. Certainly, it is also possible that a client signature rule and a server end signature rule are used at the same time. For example, if the client signature rule is intended to a certain contact, the signature template is set as follows: adding the name of the contact in the front of a sent message; the server end signature rule is intended to the contact, the signature template is set as follows: adding the name of a sending party at the end of the sent message, and if the client signature rule and the server end signature rule are used at the same time, the message sent to the contact is: the name of the contact+the content of the message+the name of the sending party. To make the setting of the signature rule meet user's requirements better, the signature rule may include a dynamic condition. When a signature template is selected according to a preset client signature rule and/or a preset server end signature rule, first, the dynamic condition in the preset client signature rule and/or the preset server end signature rule needs to be parsed to obtain a current value of the dynamic condition corresponding to the message; then, the current value of the dynamic condition corresponding to the message is matched with a set value of the dynamic condition; and later, a signature template is selected according to a matching result.

The above process of parsing and matching the dynamic condition in the signature rule is illustrated below with an example. In this example, the signature rule is as follows:

If a receiver is: 13544443333 or 13322228888, and receiver weather is: rainy, a signature template “[It is rainy, remember to bring an umbrella when going outside]” is used.

In this example, the dynamic condition in the signature rule includes a receiver and receiver weather. First, a dynamic condition in the signature rule is parsed, and current values of a receiver and receiver weather corresponding to a message to be sent can be obtained; then, the current values of the receiver and the receiver weather corresponding to the message to be sent that are obtained by parsing are matched with the set values “the receiver is: 13544443333 or 13322228888, and receiver weather is: rainy”; it is assumed that the current values of the receiver and the receiver weather corresponding to the message to be sent that are obtained by parsing are 13544443333 and rainy, respectively, then, the matching result is successful, and the signature template “[It is rainy, remember to bring an umbrella when going outside]” is selected. Certainly, if the matching result is unsuccessful, such a signature template may not be selected and no signature is used, or other signature templates may be selected, which specifically depends on the setting of the rule.

As described above, the dynamic condition in the signature rule is some variable parameters corresponding to a message to be sent, the dynamic condition is parsed, and current values of the variable parameters corresponding to the message to be sent, for example, the receiver and the receiver weather in the above example, can be obtained. For another example, when the signature rule is that a signature is used only on some specific dates, the dynamic condition in the signature rule may be the date of sending a message, the dynamic condition is parsed, and the date of sending the message can be obtained.

A signature template is signature format and content that are preset. The signature template makes the signature process more convenient. When editing a message to be sent, the user may select a preset signature template to attach signature content. The signature template in the embodiment of the present invention includes a signature variable, the signature variable is variable signature content and similar to a “variable” in programming. Signature content that changes dynamically can be obtained by parsing the signature variable in the signature template. An example of signature variables may be as follows:

@city, indicating the current city;

@time, indicating the current time;

@weather, indicating the current weather;

@holiday_wish, indicating a short holiday wish; and

@number, indicating the message number.

A signature variable in the signature template is parsed, and the signed message can be obtained. The specific implementation may include: parsing the signature variable in the signature template to obtain a current value of the signature variable corresponding to the message; and the current value of the signature variable corresponding to the message is filled in the signature template to obtain the signed message. An example is provided for illustration. It is assumed that the selected signature template includes a signature variable @time, then, the signature variable is parsed, the time of sending the message is obtained, and the time of sending the message obtained by parsing is filled in the signature template to sign the message to be sent.

According to the specific side that parses a signature variable, the signature variable may be classified as a client signature variable and a server end signature variable. The client signature variable is parsed by a client, and the server end signature variable is parsed by a server end. The client signature variable may be saved in a client signature variable library, and the server end signature variable may be saved in a server end signature variable library. In implementation, the client signature variable library may be synchronized with the server end signature variable library, so that signature parsing capabilities of the client and the server end can be used at the same time when a signature is parsed, which strengthens parsing capabilities and makes expansion be convenient.

A signature template may include either of a client signature variable and a server end signature variable, and may also include both the client signature variable and the server end signature variable. An example is provided as follows:

#Contact_Name:#SMS[Xiao'ai@city]

where #Contact_Name is a client signature variable that indicates the name of a receiver in the address book and is parsed by the client; @city is a server end signature variable that indicates the current city of a sender and is parsed by the server end; #SMS is a client signature variable that indicates the original short message content edited by a user.

If the original short message content of the user is: “I just got off the airplane” and the above signature template is selected, the short message is parsed by the client as: “Uncle: I just got off the airplane [Xiao'ai@city]”, the short message is parsed by the server end as: “Uncle: I just got off the airplane [Xiao'ai@Shenzhen]”, and the parsed short message is sent to the receiver.

When the signature variable in the signature template and the dynamic condition in the signature rule are parsed, interaction with other network elements, for example, a location server and a weather server, may be required. For example, FIG. 2 shows a process of requesting a user location from an LBS. In this example, a server end requests the user location from the LBS.

Step 201: The server end requests a user location from the location server.

Step 202: The location server returns the user location to the server end.

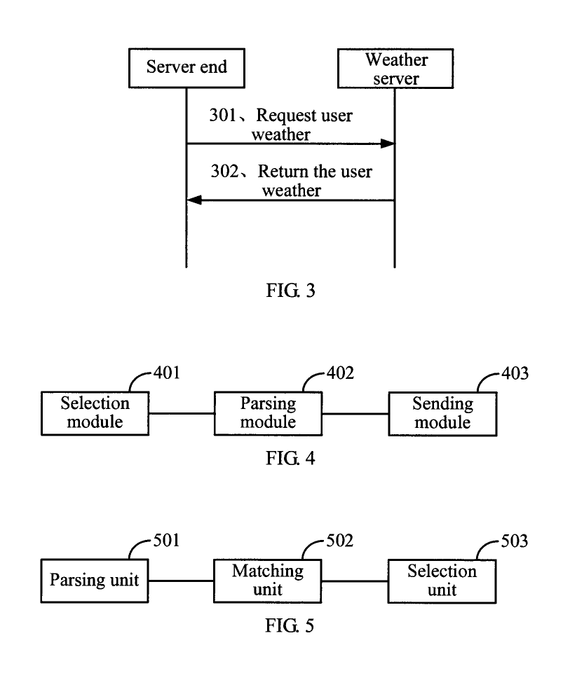

Or, FIG. 3 shows a process of requesting weather from a weather server. In this example, a server end requests the user location from the location server.

Step 301: A server end requests user weather from a weather server.

Step 302: The weather server returns the user weather to the server end.

The signed message in the embodiment of the present invention may be a short message (Short Message Service, SMS), or a multimedia message (Multimedia Messaging Service, MMS), or messages in other formats.

The format of an MMS is more complex than that of a short message. The MMS may further include picture, audio, video, link, or other content in addition to text. In an MMS signature, the signature variable may be parsed into a multimedia format other than text, for example, a map of a current location and a picture of weather forecast. For example, the @weather may be parsed into a schematic chart of current weather. The signature template may include two parts: an MMS subject and MMS content, and the signature variable may be used in the MMS subject and the MMS content.

Persons skilled in the art should understand that all or a part of the steps in the method according to the above embodiments can be implemented by a program instructing relevant hardware, and the program may be stored in a computer readable storage medium. When the program is run, all or a part of the steps in the method according to the above embodiments may be performed. The storage medium may include a ROM, a RAM, a magnetic disk, or an optical disk.

An embodiment of the present invention further provides a message signature device, as described in the following embodiment. Since the principle of a solution of the device is similar to that of the message signature method, as for the implementation of the device, reference may be made to the implementation of the method, and the repeated parts are no longer described.

As shown in FIG. 4, the message signature device in the embodiment of the present invention may include:

a selection module 401, configured to select a signature template for a message to be sent, where the signature template includes a signature variable;

a parsing module 402, configured to parse the signature variable in the signature template to obtain a current value of the signature variable, and fill the current value of the signature variable in the signature template to obtain a signed message; and

a sending module 403, configured to send the signed message.

In an embodiment, the selection module 401 may further be configured to select the signature template according to a preset client signature rule and/or a preset server end signature rule.

As shown in FIG. 5, in an embodiment, the client signature rule and the server end signature rule include a preset dynamic condition; the selection module 401 may include:

a parsing unit 501, configured to parse a dynamic condition in the preset client signature rule and/or the preset server end signature rule to obtain a current value of the dynamic condition corresponding to the message to be sent;

a matching unit 502, configured to match the current value of the dynamic condition corresponding to the message to be sent with a set value of the dynamic condition; and

a selection unit 503, configured to select the signature template according to a matching result.

In an embodiment, the signature variable in the signature template may include: a client signature variable parsed by a client and/or a server end signature variable parsed by a server end.

In specific implementation, the message signature device may be located on the client or the server end, or, the functions of the message signature device may be implemented by the client and the server end together, which specifically depends on the selection of the signature template of the message and the specific side that parses the signature variable. For example, if a signature template is selected according to a client signature rule or selected manually by a user during message signing, and the selected signature template includes a client signature variable parsed by the client, the message signature device is located on the client, and the client implements the functions of the selection module 401, the parsing module 402, and the sending module 403 shown in FIG. 4. If a signature template is selected according to a server end signature rule during message signing, and the selected signature template includes a server end signature variable parsed by the server end, the message signature device is located on the server end, and the server end implements the functions of the selection module 401, the parsing module 402, and the sending module 403 shown in FIG. 4. If a signature template is selected according to a client signature rule or selected manually by the user during message signing, and the selected signature template includes a server end signature variable parsed by the server end, the functions of the message signature device are implemented by the client and the server end together, in which the client implements the function of the selection module 401 shown in FIG. 4, and the server end implements the functions of the parsing module 402 and the sending module 403 shown in FIG. 4.

The signed message in the above embodiment may be a short message (SMS), or a multimedia message (MMS, also referred to as a multimedia message), or messages in other formats.

The specific implementation of the device according to the above embodiment applied in short message signature is illustrated below with an example. In this example, the division of functional modules of the client and the server end is a specific example, and the functional modules may also be added or deleted and/or combined in implementation, as long as the functions of the device and the module in FIG. 4 to FIG. 5 can be implemented. In this example, the client and the server end together implement the functions of the device and the module in FIG. 4 to FIG. 5.

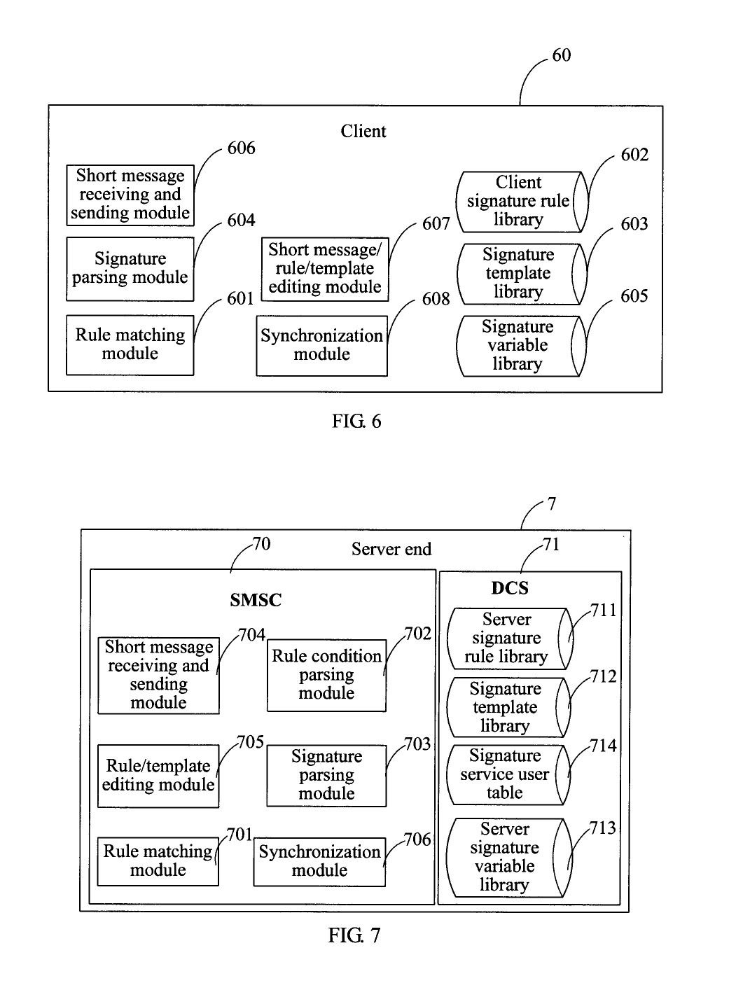

As shown in FIG. 6, in a client 60 for short message signature in this example, a rule matching module 601, a client signature rule library 602, and a signature template library 603 can assist in implementing the function of the selection module 401; a signature parsing module 604 can assist in implementing the function of the parsing module 402. In addition, the client 60 may further include:

a signature variable library 605, configured to save a client signature variable and further configured to save a server end signature variable; also configured to save fields including a signature type (client, server end), a variable name, and a signature description;

a short message receiving and sending module 606, configured to send and receiving a short message to/from the server end;

a short message/rule/template editing module 607, configured to generate a signature template; and

a synchronization module 608, configured to synchronize data with the server end; in one aspect, synchronization is for the purpose of sharing data between different clients; in addition, synchronization of a signature variable enables the user to use the dynamic signature capability of the server end conveniently.

As shown in FIG. 7, in a server end 7 for short message signature in this example, a rule matching module 701 and a rule condition parsing module 702 of an SMSC 70, and a server signature rule library 711 and a signature template library 712 of a data center for short message service DCS 71 can assist in implementing the function of the selection module 401; a signature parsing module 703 of the SMSC 70 and a server signature variable library 713 of the DCS 71 can assist in implementing the function of the parsing module 402; a short message receiving and sending module 704 of the SMSC 70 can implement the function of the sending module 403.

In addition, the SMSC 70 may further include:

a rule/template editing module 705, configured to generate a signature template; and

a synchronization module 706, configured to synchronize data with the client, including synchronizing the signature template and a signature variable.

The DCS 71 may further include: a signature service user table 714, configured to record some user information.

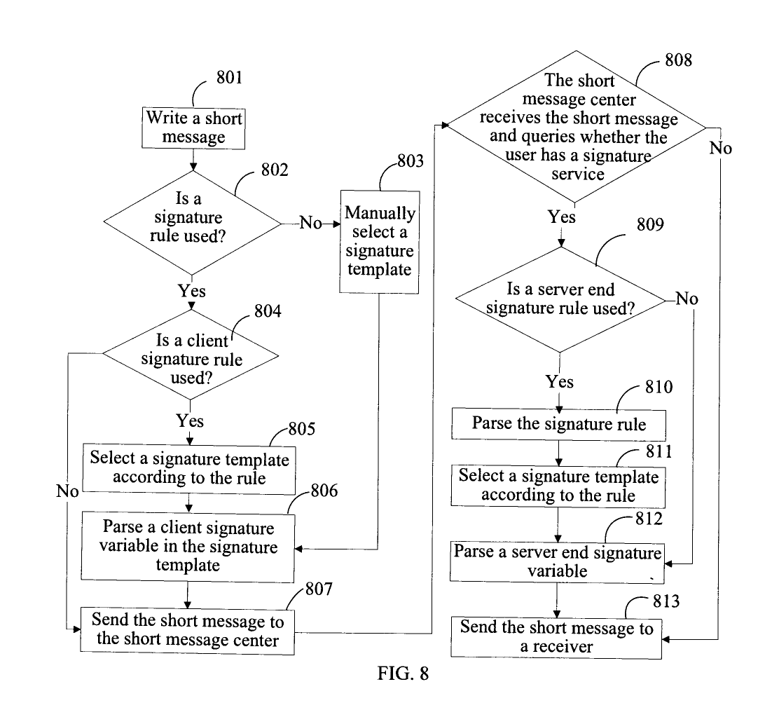

A specific example of a processing flow of applying the client shown in FIG. 6 and the server end shown in FIG. 7 in short message signature is illustrated below. As shown in FIG. 8, the processing flow of the client may include the following steps:

Step 801: A user writes short message content to be sent.

Step 802: Judge whether a signature rule is used to automatically select a signature template, and if not, perform step 803; if yes, perform step 804.

Step 803: A user manually selects a signature template, and the flow turns to step 806.

Step 804: Judge whether a client signature rule is used, and if yes, perform step 805; if not, perform step 807.

Step 805: Select the client signature rule set by the user, and the rule matching module 601 selects a signature template according to the selected client signature rule, which includes: parsing a dynamic condition in the client signature rule to obtain a current value of the dynamic condition corresponding to the short message to be sent; matching the current value with a set value of the dynamic condition in the client signature rule library 602; and selecting the signature template from the signature template library 603 according to a matching result.

Step 806: The signature parsing module 604 parses a client signature variable in the signature template to obtain a current value of the client signature variable, and fills the current value in the signature template to obtain a short message signed by the client.

Step 807: The short message receiving and sending module 606 sends the short message signed by the client to the server end.

The processing flow of the server end may include the following steps:

Step 808: The SMSC 70 receives the short message signed by the client, and queries whether the user has a signature service from the DCS 71, and if yes, perform step 809; if not, perform step 813.

Step 809: Judge whether a server end signature rule is used, and if yes, perform step 810; if not, perform step 812.

Step 810: The SMSC 70 requests obtaining the server end signature rule from the DCS 71, and the rule condition parsing module 702 parses a dynamic condition in the server end signature rule to obtain a current value of the dynamic condition.

Step 811: The rule matching module 701 matches the current value of the dynamic condition with a set value of the dynamic condition in the server signature rule library 711, and selects a signature template from the signature template library 712 according to a matching result.

Step 812: The signature parsing module 703 parses a server end signature variable in the signature template to obtain a current value of the server end signature variable, and fills the current value in the signature template to obtain a short message signed by the server end.

Step 813: The short message receiving and sending module 704 sends the short message signed by the server end and/or the client to a called user.

The above example also illustrates that when a short message is sent, a signature template may be selected by the client according to a client signature rule, and a signature template may also be selected by the server end according to a server end signature rule, meanwhile, when the two rules are used at the same time, two signature templates are actually attached to the short message content to be sent, and the client and the server end a parse signature variable in their respective selected signature templates.

Similarly, the specific implementation of the method according to the embodiment of the present invention applied in multimedia message signature is illustrated below with an example. In this example, the division of functional modules of the client and the server end is a specific example, and the functional modules may also be added or deleted and/or combined in implementation, as long as the functions of the device and the module in FIG. 4 to FIG. 5 can be implemented. In this example, the client and the server end together implement the functions of the device and the module in FIG. 4 to FIG. 5.

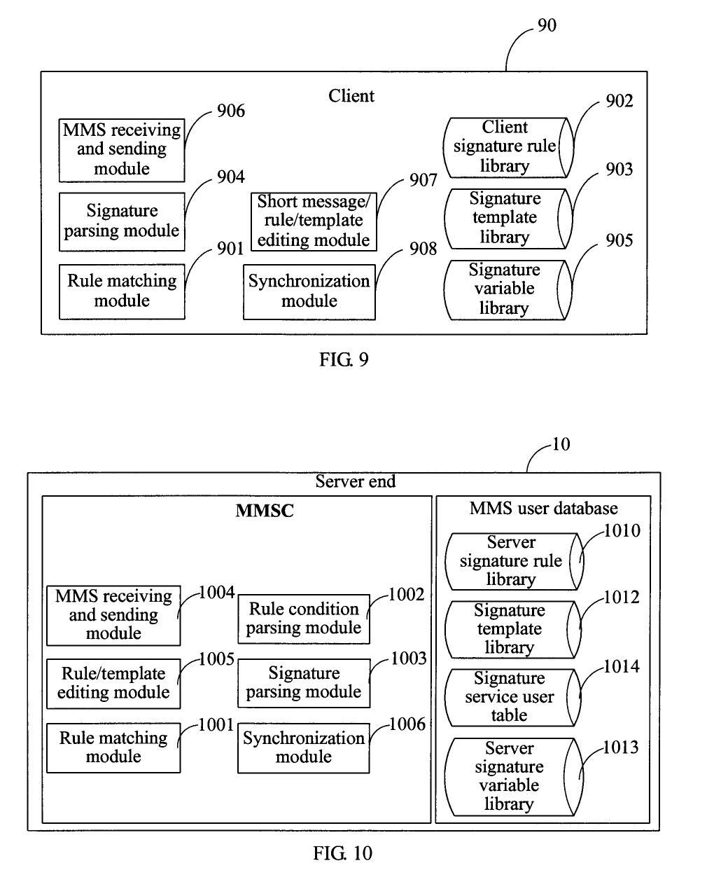

As shown in FIG. 9, in a client 90 for multimedia message signature in this example, a rule matching module 901, a client signature rule library 902, and a signature template library 903 can assist in implementing the function of the selection module 401; a signature parsing module 904 can assist in implementing the function of the parsing module 402. In addition, the client 90 may further include:

a signature variable library 905, configured to save a client signature variable and further configured to save a server end signature variable; configured to save fields including signature type (client, server end), variable name, and signature description;

an MMS receiving and sending module 906, configured to send a multimedia message to the server end;

an MMS/rule/template editing module 907, configured to generate a signature template; and

a synchronization module 908, configured to synchronize data with the server end; in one aspect, synchronization is for the purpose of sharing data between different clients; in addition, synchronization of a signature variable enables the user to use the dynamic signature capability of the server end conveniently.

As shown in FIG. 10, in a server end 10 for multimedia message signature in this example, a rule matching module 1001 and a rule condition parsing module 1002 of an MMSC (Multimedia Message Service Center, multimedia message center), and a server signature rule library 1011 and a signature template library 1012 of an MMS user database can assist in implementing the function of the selection module 401; a signature parsing module 1003 of the MMSC and a server signature variable library 1013 of the MMS user database can assist in implementing the function of the parsing module 402; an MMS receiving and sending module 1004 of the MMSC can implement the function of the sending module 403. In addition, the MMSC may further include:

a rule/template editing module 1005, configured to generate a signature template; and

a synchronization module 1006, configured to synchronize data with the client, including synchronizing the signature template and a signature variable.

The MMS user database may further include: a signature service user table 1014, configured to record some user information.

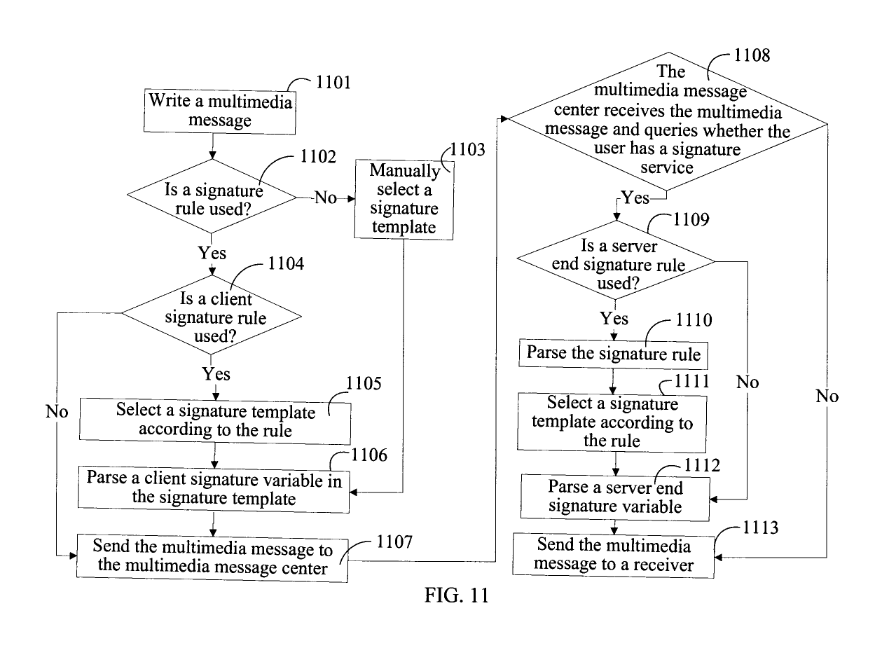

A specific example of a processing flow of applying the client shown in FIG. 9 and the server end shown in FIG. 10 in multimedia message signature is illustrated below. As shown in FIG. 11, the processing flow of the client may include the following steps:

Step 1101: A user writes multimedia message content to be sent.

Step 1102: Judge whether a signature rule is used to automatically select a signature template, and if not, perform step 1103; if yes, perform step 1104.

Step 1103: The user manually selects a signature template, and the flow turns to step 1106.

Step 1104: Judge whether a client signature rule is used, and if yes, perform step 1105; if not, perform step 1107.

Step 1105: Select the client signature rule set by the user, and the rule matching module 901 selects a signature template according to the selected client signature rule, which includes: parsing a dynamic condition in the client signature rule to obtain a current value of the dynamic condition corresponding to the multimedia message to be sent; matching the current value with a set value of the dynamic condition in the client signature rule library 902; and selecting the signature template from the signature template library 903 according to a matching result.

Step 1106: The signature parsing module 904 parses a client signature variable in the signature template to obtain a current value of the client signature variable, and fills the current value in the signature template to obtain a multimedia message signed by the client.

Step 1107: The MMS receiving and sending module 906 sends the multimedia message signed by the client to the server end.

The processing flow of the server end may include the following steps:

Step 1108: The MMSC receives the multimedia message signed by the client, and queries whether the user has a signature service from the MMS user database, and if yes, perform step 1109; if not, perform step 1113.

Step 1109: Judge whether a server end signature rule is used, and if yes, perform step 1110; if not, perform step 1112.

Step 1110: The MMSC requests obtaining the server end signature rule from the MMS user database, and the rule condition parsing module 1002 parses a dynamic condition in the server end signature rule to obtain a current value of the dynamic condition.

Step 1111: The rule matching module 1001 matches the current value of the dynamic condition with a set value of the dynamic condition in the server signature rule library 1011, and selects a signature template from the signature template library 1012 according to a matching result.

Step 1112: The signature parsing module 1003 parses a server end signature variable in the signature template to obtain a current value of the server end signature variable, and fills the current value in the signature template to obtain a multimedia message signed by the server end.

Step 1113: The MMS receiving and sending module 1004 sends the multimedia message signed by the server end and/or the client to a called user.

As can be known from the above embodiments, in the embodiments of the present invention, a signature template that includes a signature variable is selected for a message to be sent; and the signature variable in the signature template is parsed to obtain a current value of the signature variable, and the current value of the signature variable is filled in the signature template to obtain a signed message. During the implementation of signature, signature content that changes dynamically can be obtained by parsing the signature variable in the signature template without user operation or client upgrade, which makes the message signature more interesting and personalized, easy to be implemented, and highly practicable.

In the embodiments of the present invention, the signature template is selected according to a preset client signature rule or server end signature rule, in which the signature rule may include a dynamic condition, so that the setting of the signature rule meets the user's requirements better.

The objectives, technical solutions, and beneficial effects of the present invention have been illustrated in further detail through the above specific embodiments. It should be understood that the above descriptions are merely specific embodiments of the present invention, but not intended to limit the protection scope of the present invention. Any modification, equivalent replacement, or improvement made without departing from the spirit and principle of the present invention should fall within the protection scope of the present invention.

What is claimed is:

1. A message signature method, comprising:
selecting a signature template for a message to be sent, wherein the signature template comprises a signature variable;
parsing the signature variable in the signature template to obtain a current value of the signature variable, and filling the current value of the signature variable in the signature template to obtain a signed message; and
sending the signed message.

2. The method according to claim 1, wherein the selecting the signature template for the message to be sent comprises:
selecting the signature template according to a preset client signature rule and/or a preset server end signature rule.

3. The method according to claim 2, wherein
the client signature rule and the server end signature rule comprise a preset dynamic condition; and
the selecting the signature template according to the preset client signature rule and/or the preset server end signature rule specifically comprises:
parsing a dynamic condition in the preset client signature rule and/or the preset server end signature rule to obtain a current value of the dynamic condition corresponding to the message to be sent;
matching the current value of the dynamic condition corresponding to the message to be sent with a set value of the dynamic condition; and
selecting the signature template according to a matching result.

4. The method according to claim 1, wherein the signature variable in the signature template comprises:
a client signature variable parsed by a client and/or a server end signature variable parsed by a server end.

5. A message signature device, comprising:
a selection module, configured to select a signature template for a message to be sent, wherein the signature template comprises a signature variable;
a parsing module, configured to parse the signature variable in the signature template to obtain a current value of the signature variable, and fill the current value of the signature variable in the signature template to obtain a signed message; and
a sending module, configured to send the signed message.

6. The device according to claim 5, wherein the selection module is further configured to select the signature template according to a preset client signature rule and/or a preset server end signature rule.

7. The device according to claim 6, wherein the client signature rule and the server end signature rule comprise a preset dynamic condition; and
the selection module comprises:
a parsing unit, configured to parse a dynamic condition in the preset client signature rule and/or the preset server end signature rule to obtain a current value of the dynamic condition corresponding to the message to be sent;
a matching unit, configured to match the current value of the dynamic condition corresponding to the message to be sent with a set value of the dynamic condition; and
a selection unit, configured to select the signature template according to a matching result.

8. The device according to claim 5, wherein the signature variable in the signature template comprises: a client signature variable parsed by a client and/or a server end signature variable parsed by a server end.
